(19) United States
(12) Patent Application Publication
(10) Pub. No.: US 2026/0343488 A1
(43) Pub. Date: Oct. 29, 2026

(54) ESTIMATING POSITION OF USER DEVICE

(71) Applicant: Nokia Technologies Oy, Espoo (FI)

(72) Inventors: Johannes HARREBEK, Aalborg (DK); Benny VEJLGAARD, Gistrup (DK); Oana-Elena BARBU, Aalborg (DK)

(21) Appl. No.: 19/119,603

(22) PCT Filed: Sep. 12, 2023
(86) PCT No.: PCT/EP2023/074942

§ 371 Date: Apr. 9, 2025

(30) Foreign Application Priority Data
Oct. 10, 2022 (GB) 2214878.7

(51) Int. Cl. H04W 64/00; H04W 24/10; H04W 52/02; H04W 76/10; H04W 76/28

(52) U.S. Cl. CPC H04W 64/006; H04W 24/10; H04W 52/0216; H04W 76/10; H04W 76/28

(57) ABSTRACT

Disclosed is a method comprising obtaining first information indicating a first time difference between a transmission of a wake-up signal from a first network node and a reception of a reference signal at the first network node; obtaining second information indicating a second time difference between a reception of the wake-up signal at a user device and a transmission of the reference signal from the user device; and estimating a position of the user device based at least partly on the first information and the second information.

### FIELD

The following example embodiments relate to wireless communication and to positioning.

### BACKGROUND

Positioning technologies may be used to estimate a location of a device. It is desirable to improve the positioning accuracy in order to estimate the location of the device more accurately.

### BRIEF DESCRIPTION

The scope of protection sought for various example embodiments is set out by the claims. The example embodiments and features, if any, described in this specification that do not fall under the scope of the claims are to be interpreted as examples useful for understanding various embodiments.

According to an aspect, there is provided an apparatus comprising at least one processor, and at least one memory storing instructions which, when executed by the at least one processor, cause the apparatus at least to: obtain first information indicating a first time difference between a transmission of a wake-up signal from a first network node and a reception of a reference signal at the first network node; obtain second information indicating a second time difference between a reception of the wake-up signal at a user device and a transmission of the reference signal from the user device; and estimate a position of the user device based at least partly on the first information and the second information.

According to another aspect, there is provided an apparatus comprising: means for obtaining first information indicating a first time difference between a transmission of a wake-up signal from a first network node and a reception of a reference signal at the first network node; means for obtaining second information indicating a second time difference between a reception of the wake-up signal at a user device and a transmission of the reference signal from the user device; and means for estimating a position of the user device based at least partly on the first information and the second information.

According to another aspect, there is provided a method comprising: obtaining first information indicating a first time difference between a transmission of a wake-up signal from a first network node and a reception of a reference signal at the first network node; obtaining second information indicating a second time difference between a reception of the wake-up signal at a user device and a transmission of the reference signal from the user device; and estimating a position of the user device based at least partly on the first information and the second information.

According to another aspect, there is provided a computer program comprising instructions which, when executed by an apparatus, cause the apparatus to perform at least the following: obtaining first information indicating a first time difference between a transmission of a wake-up signal from a first network node and a reception of a reference signal at the first network node; obtaining second information indicating a second time difference between a reception of the wake-up signal at a user device and a transmission of the reference signal from the user device; and estimating a position of the user device based at least partly on the first information and the second information.

According to another aspect, there is provided a computer readable medium comprising program instructions which, when executed by an apparatus, cause the apparatus to perform at least the following: obtaining first information indicating a first time difference between a transmission of a wake-up signal from a first network node and a reception of a reference signal at the first network node; obtaining second information indicating a second time difference between a reception of the wake-up signal at a user device and a transmission of the reference signal from the user device; and estimating a position of the user device based at least partly on the first information and the second information.

According to another aspect, there is provided a non-transitory computer readable medium comprising program instructions which, when executed by an apparatus, cause the apparatus to perform at least the following: obtaining first information indicating a first time difference between a transmission of a wake-up signal from a first network node and a reception of a reference signal at the first network node; obtaining second information indicating a second time difference between a reception of the wake-up signal at a user device and a transmission of the reference signal from the user device; and estimating a position of the user device based at least partly on the first information and the second information.

According to another aspect, there is provided an apparatus comprising at least one processor, and at least one memory storing instructions which, when executed by the at least one processor, cause the apparatus at least to: determine a second time difference between a reception of a wake-up signal at the apparatus and a transmission of a reference signal from the apparatus; and report information indicating the second time difference.

According to another aspect, there is provided an apparatus comprising: means for determining a second time difference between a reception of a wake-up signal at the apparatus and a transmission of a reference signal from the apparatus; and means for reporting information indicating the second time difference.

According to another aspect, there is provided a method comprising: determining, by an apparatus, a second time difference between a reception of a wake-up signal at the apparatus and a transmission of a reference signal from the apparatus; and reporting, by the apparatus, information indicating the second time difference.

According to another aspect, there is provided a computer program comprising instructions which, when executed by an apparatus, cause the apparatus to perform at least the following: determining a second time difference between a reception of a wake-up signal at the apparatus and a transmission of a reference signal from the apparatus; and reporting information indicating the second time difference.

According to another aspect, there is provided a computer readable medium comprising program instructions which, when executed by an apparatus, cause the apparatus to perform at least the following: determining a second time difference between a reception of a wake-up signal at the apparatus and a transmission of a reference signal from the apparatus; and reporting information indicating the second time difference.

According to another aspect, there is provided a non-transitory computer readable medium comprising program instructions which, when executed by an apparatus, cause the apparatus to perform at least the following: determining a second time difference between a reception of a wake-up signal at the apparatus and a transmission of a reference signal from the apparatus; and reporting information indicating the second time difference.

According to another aspect, there is provided an apparatus comprising at least one processor, and at least one memory storing instructions which, when executed by the at least one processor, cause the apparatus at least to: determine a first time difference between a transmission of a wake-up signal from the apparatus and a reception of a reference signal at the apparatus; and report information indicating the first time difference.

According to another aspect, there is provided an apparatus comprising: means for determining a first time difference between a transmission of a wake-up signal from the apparatus and a reception of a reference signal at the apparatus; and means for reporting information indicating the first time difference.

According to another aspect, there is provided a method comprising: determining, by an apparatus, a first time difference between a transmission of a wake-up signal from the apparatus and a reception of a reference signal at the apparatus; and reporting, by the apparatus, information indicating the first time difference

According to another aspect, there is provided a computer program comprising instructions which, when executed by an apparatus, cause the apparatus to perform at least the following: determining a first time difference between a transmission of a wake-up signal from the apparatus and a reception of a reference signal at the apparatus; and reporting information indicating the first time difference.

According to another aspect, there is provided a computer readable medium comprising program instructions which, when executed by an apparatus, cause the apparatus to perform at least the following: determining a first time difference between a transmission of a wake-up signal from the apparatus and a reception of a reference signal at the apparatus; and reporting information indicating the first time difference.

According to another aspect, there is provided a non-transitory computer readable medium comprising program instructions which, when executed by an apparatus, cause the apparatus to perform at least the following: determining a first time difference between a transmission of a wake-up signal from the apparatus and a reception of a reference signal at the apparatus; and reporting information indicating the first time difference.

### LIST OF DRAWINGS

In the following, various example embodiments will be described in greater detail with reference to the accompanying drawings, in which

FIG. 1 illustrates an example of a cellular communication network;

FIG. 2 illustrates an example of a wake-up receiver architecture of a user device;

FIG. 3 illustrates an example of a system;

FIG. 4 illustrates a signaling diagram;

FIG. 5 illustrates a flow chart;

FIG. 6 illustrates a flow chart;

FIG. 7 illustrates a flow chart;

FIG. 8 illustrates an example of the series of events in an example embodiment;

FIG. 9 illustrates an example of an apparatus;

FIG. 10 illustrates an example of an apparatus; and

FIG. 11 illustrates an example of an apparatus.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

In the following, different example embodiments will be described using, as an example of an access architecture to which the example embodiments may be applied, a radio access architecture based on long term evolution advanced (LTE Advanced, LTE-A), new radio (NR, 5G), beyond 5G, or sixth generation (6G) without restricting the example embodiments to such an architecture, however. It is obvious for a person skilled in the art that the example embodiments may also be applied to other kinds of communications networks having suitable means by adjusting parameters and procedures appropriately. Some examples of other options for suitable systems may be the universal mobile telecommunications system (UMTS) radio access network (UTRAN or E-UTRAN), long term evolution (LTE, substantially the same as E-UTRA), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

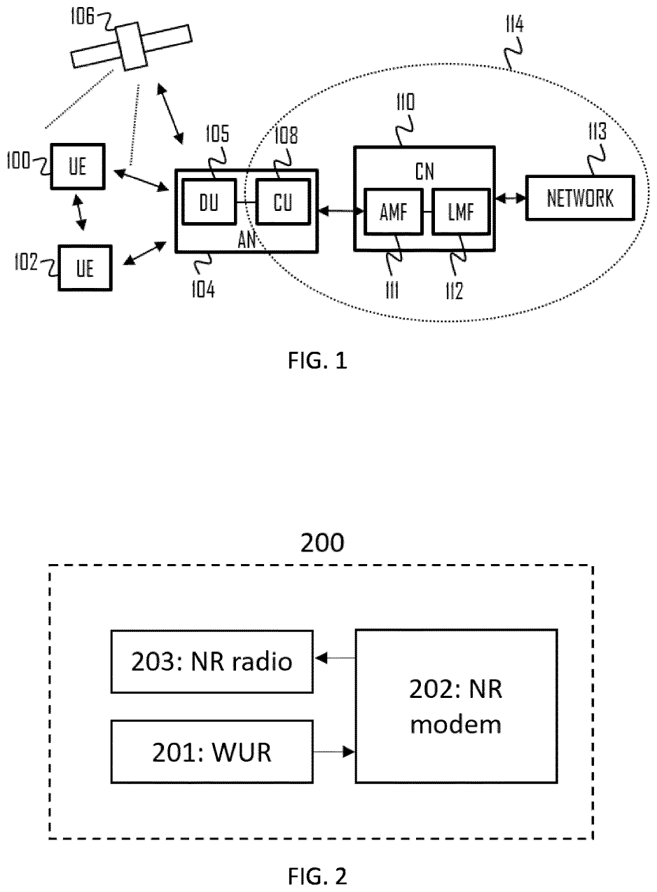

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may also comprise other functions and structures than those shown in FIG. 1.

The example embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a radio cell with an access node (AN) 104, such as an evolved Node B (abbreviated as eNB or eNodeB) or a next generation Node B (abbreviated as gNB or gNodeB), providing the radio cell. The physical link from a user device to an access node may be called uplink (UL) or reverse link, and the physical link from the access node to the user device may be called downlink (DL) or forward link. A user device may also communicate directly with another user device via sidelink (SL) communication. It should be appreciated that access nodes or their functionalities may be implemented by using any node, host, server or access point etc. entity suitable for such a usage.

A communication system may comprise more than one access node, in which case the access nodes may also be configured to communicate with one another over links, wired or wireless, designed for the purpose. These links may be used for signaling purposes and also for routing data from one access node to another. The access node may be a computing device configured to control the radio resources of communication system it is coupled to. The access node may also be referred to as a base station, a base transceiver station (BTS), an access point or any other type of interfacing device including a relay station capable of operating in a wireless environment. The access node may include or be coupled to transceivers. From the transceivers of the access node, a connection may be provided to an antenna unit that establishes bi-directional radio links to user devices. The antenna unit may comprise a plurality of antennas or antenna elements. The access node may further be connected to a core network 110 (CN or next generation core NGC). Depending on the deployed technology, the counterpart that the access node may be connected to on the CN side may be a serving gateway (S-GW, routing and forwarding user data packets), packet data network gateway (P-GW) for providing connectivity of user devices to external packet data networks, user plane function (UPF), mobility management entity (MME), or an access and mobility management function (AMF), etc.

With respect to positioning, the service-based architecture (core network) may comprise an AMF 111 and a location management function (LMF) 112. The AMF may provide location information for call processing, policy, and charging to other network functions in the core network and to other entities requesting for positioning of user devices. The AMF may receive and manage location requests from several sources: mobile-originated location requests (MO-LR) from the user devices and mobile-terminated location requests (MT-LR) from other functions of the core network or from other network nodes. The AMF may select the LMF for a given request and use its positioning service to trigger a positioning session. The LMF may then carry out the positioning upon receiving such a request from the AMF. The LMF may manage the resources and timing of positioning activities. The LMF may use a Namf_Communication service on an NL1 interface to request positioning of a user device from one or more access nodes, or the LMF may communicate with the user device over N1 for UE-based or UE-assisted positioning. The positioning may include estimation of a location and, additionally, the LMF may also estimate movement or accuracy of the location information when requested. Connection-wise, the AMF may be between the access node and the LMF and, thus, closer to the access nodes than the LMF.

The user device illustrates one type of an apparatus to which resources on the air interface may be allocated and assigned, and thus any feature described herein with a user device may be implemented with a corresponding apparatus, such as a relay node.

An example of such a relay node may be a layer 3 relay (self-backhauling relay) towards the access node. The self-backhauling relay node may also be called an integrated access and backhaul (IAB) node. The IAB node may comprise two logical parts: a mobile termination (MT) part, which takes care of the backhaul link(s) (i.e., link(s) between IAB node and a donor node, also known as a parent node) and a distributed unit (DU) part, which takes care of the access link(s), i.e., child link(s) between the IAB node and user device(s), and/or between the IAB node and other IAB nodes (multi-hop scenario).

Another example of such a relay node may be a layer 1 relay called a repeater. The repeater may amplify a signal received from an access node and forward it to a user device, and/or amplify a signal received from the user device and forward it to the access node.

The user device may also be called a subscriber unit, mobile station, remote terminal, access terminal, user terminal, terminal device, or user equipment (UE) just to mention but a few names or apparatuses. The user device may refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, multimedia device, reduced capability (RedCap) device, wireless sensor device, or any device integrated in a vehicle.

It should be appreciated that a user device may also be a nearly exclusive uplink-only device, of which an example may be a camera or video camera loading images or video clips to a network. A user device may also be a device having capability to operate in Internet of Things (IoT) network which is a scenario in which objects may be provided with the ability to transfer data over a network without requiring human-to-human or human-to-computer interaction. The user device may also utilize cloud. In some applications, a user device may comprise a small portable or wearable device with radio parts (such as a watch, earphones or eyeglasses) and the computation may be carried out in the cloud or in another user device. The user device (or in some example embodiments a layer 3 relay node) may be configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question may have inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications may support a wide range of use cases and related applications including video streaming, augmented reality, different ways of data sharing and various forms of machine type applications (such as (massive) machine-type communications (mMTC), including vehicular safety, different sensors and real-time control. 5G may have multiple radio interfaces, namely below 6 GHz, cmWave and mmWave, and also being integrable with existing legacy radio access technologies, such as the LTE. Integration with the LTE may be implemented, at least in the early phase, as a system, where macro coverage may be provided by the LTE, and 5G radio interface access may come from small cells by aggregation to the LTE. In other words, 5G may support both inter-RAT operability (such as LTE-5G) and inter-RI operability (inter-radio interface operability, such as below 6 GHz-cmWave-mmWave). One of the concepts considered to be used in 5G networks may be network slicing, in which multiple independent and dedicated virtual sub-networks (network instances) may be created within the substantially same infrastructure to run services that have different requirements on latency, reliability, throughput and mobility.

The current architecture in LTE networks may be fully distributed in the radio and fully centralized in the core network. The low latency applications and services in 5G may need to bring the content close to the radio which leads to local break out and multi-access edge computing (MEC). 5G may enable analytics and knowledge generation to occur at the source of the data. This approach may need leveraging resources that may not be continuously connected to a network such as laptops, smartphones, tablets and sensors. MEC may provide a distributed computing environment for application and service hosting. It may also have the ability to store and process content in close proximity to cellular subscribers for faster response time. Edge computing may cover a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system may also be able to communicate with one or more other networks 113, such as a public switched telephone network or the Internet, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or the like, providing facilities for networks of different operators to cooperate for example in spectrum sharing.

An access node may also be split into: a radio unit (RU) comprising a radio transceiver (TRX), i.e., a transmitter (Tx) and a receiver (Rx); one or more distributed units (DUs) 105 that may be used for the so-called Layer 1 (L1) processing and real-time Layer 2 (L2) processing; and a central unit (CU) 108 (also known as a centralized unit) that may be used for non-real-time L2 and Layer 3 (L3) processing. The CU 108 may be connected to the one or more DUs 105 for example via an F1 interface. Such a split may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU 108 may be defined as a logical node hosting higher layer protocols, such as radio resource control (RRC), service data adaptation protocol (SDAP) and/or packet data convergence protocol (PDCP), of the access node. The DU 105 may be defined as a logical node hosting radio link control (RLC), medium access control (MAC) and/or physical (PHY) layers of the access node. The operation of the DU may be at least partly controlled by the CU. The CU may comprise a control plane (CU-CP), which may be defined as a logical node hosting the RRC and the control plane part of the PDCP protocol of the CU for the access node. The CU may further comprise a user plane (CU-UP), which may be defined as a logical node hosting the user plane part of the PDCP protocol and the SDAP protocol of the CU for the access node.

Cloud computing platforms may also be used to run the CU 108 and/or DU 105. The CU may run in a cloud computing platform, which may be referred to as a virtualized CU (vCU). In addition to the vCU, there may also be a virtualized DU (vDU) running in a cloud computing platform. Furthermore, there may also be a combination, where the DU may use so-called bare metal solutions, for example application-specific integrated circuit (ASIC) or customer-specific standard product (CSSP) system-on-a-chip (SoC) solutions. It should also be understood that the distribution of functions between the above-mentioned access node units, or different core network operations and access node operations, may differ.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head (RRH) or a radio unit (RU), or an access node comprising radio parts. It is also possible that node operations may be distributed among a plurality of servers, nodes or hosts. Application of cloudRAN architecture enables RAN real-time functions being carried out at the RAN side (e.g., in a DU 105) and non-real-time functions being carried out in a centralized manner (e.g., in a CU 108).

It should also be understood that the distribution of functions between core network operations and access node operations may differ from that of the LTE or even be non-existent. Some other technology advancements that may be used include big data and all-IP, which may change the way networks are being constructed and managed. 5G (or new radio, NR) networks may be designed to support multiple hierarchies, where MEC servers may be placed between the core and the access node. It should be appreciated that MEC may be applied in 4G networks as well.

5G may also utilize non-terrestrial communication, for example satellite communication, to enhance or complement the coverage of 5G service, for example by providing backhauling. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano)satellites are deployed). A given satellite 106 in the mega-constellation may cover several satellite-enabled network entities that create on-ground cells. The on-ground cells may be created through an on-ground relay node or by an access node 104 located on-ground or in a satellite.

6G networks are expected to adopt flexible decentralized and/or distributed computing systems and architecture and ubiquitous computing, with local spectrum licensing, spectrum sharing, infrastructure sharing, and intelligent automated management underpinned by mobile edge computing, artificial intelligence, short-packet communication and blockchain technologies. Key features of 6G may include intelligent connected management and control functions, programmability, integrated sensing and communication, reduction of energy footprint, trustworthy infrastructure, scalability and affordability. In addition to these, 6G is also targeting new use cases covering the integration of localization and sensing capabilities into system definition to unifying user experience across physical and digital worlds.

It is obvious for a person skilled in the art that the depicted system is only an example of a part of a radio access system and in practice, the system may comprise a plurality of access nodes, the user device may have access to a plurality of radio cells and the system may also comprise other apparatuses, such as physical layer relay nodes or other network nodes, etc. At least one of the access nodes may be a Home eNodeB or a Home gNodeB.

Additionally, in a geographical area of a radio communication system, a plurality of different kinds of radio cells as well as a plurality of radio cells may be provided. Radio cells may be macro cells (or umbrella cells) which may be large cells having a diameter of up to tens of kilometers, or smaller cells such as micro-, femto-or picocells. The access node(s) of FIG. 1 may provide any kind of these cells. A cellular radio system may be implemented as a multilayer network including several kinds of radio cells. In multilayer networks, one access node may provide one kind of a radio cell or radio cells, and thus a plurality of access nodes may be needed to provide such a network structure.

For fulfilling the need for improving the deployment and performance of communication systems, the concept of “plug-and-play” access nodes may be introduced. A network which may be able to use “plug-and-play” access nodes, may include, in addition to Home eNodeBs or Home gNodeBs, a Home Node B gateway, or HNB-GW (not shown in FIG. 1). An HNB-GW, which may be installed within an operator's network, may aggregate traffic from a large number of Home eNodeBs or Home gNodeBs back to a core network.

Positioning technologies may be used to estimate a position (e.g., geographic location) of a user device. Herein the user device to be positioned is referred to as a target UE or target user device. For example, the positioning techniques used in NR may be based on at least one of the following: time difference of arrival (TDoA), time of arrival (TOA), time of departure (TOD), round trip time (RTT), angle of departure (AoD), angle of arrival (AoA), and/or carrier phase.

Low power high accuracy positioning (LPHAP) may be used for example for industrial IoT (IIoT) scenarios including use cases such as massive asset tracking, automated guided vehicle (AGV) tracking in an industrial factory, and person localization in danger zones. Requirements for LPHAP may include high positioning accuracy and extremely low power consumption with a battery life sustainable up to one or more years. An example use case may involve tracking of a workpiece (indoor and outdoor) in an assembly area and warehouse with a target positioning accuracy of less than 1 meter, a positioning interval of 15-30 seconds, and a battery life of 6-12 months. While NR Release 17 positioning has introduced support for positioning in RRC_INACTIVE state, there is a need to evaluate whether the current RAN functionality allows LPHAP requirements to be fulfilled.

Regarding IoT applications, the 3^{rd} generation partnership project (3GPP) has specified narrowband IoT (NB-IoT), enhanced machine type communication (eMTC), and NR reduced capability (RedCap) before NR Release 18 to satisfy the requirements on low-complexity and low-power devices for wide-area IoT communication. For example, these IoT devices may consume tens or hundreds of milliwatts of power during transceiving. However, to achieve the internet of everything, loT devices with even lower power consumption may be needed, for example for applications requiring batteryless devices.

The number of IoT connections has been growing rapidly in recent years and is predicted to be hundreds of billions by 2030. With more and more ‘things’ expected to be interconnected for improving production efficiency and increasing the comforts of life, further reduction of size, complexity, and power consumption may be needed for loT devices. For example, replacing the battery of IoT devices may be impractical due to the large consumption of materials and manpower.

### However, Energy May Be Harvested From the Environment to

power loT devices for self-sustainable communications, for example in applications with a very large number of devices (e.g., ID tags and sensors). For example, energy may be harvested by collecting solar energy, piezoelectric energy, or radio wave energy. Radio wave energy conversion may be used to collect, for example, radio-frequency identification (RFID), near-field communication (NFC), Bluetooth, 4G, 5G, WiFi and other radio wave energy in the surrounding environment and convert it into electrical energy.

One issue with current 3GPP technologies for the target use cases is the capability of cooperating with energy harvesting considering the limited device size. Cellular devices may consume tens or even hundreds of milliwatts of power for the transceiving processing. Taking an NB-IOT module as an example, the current absorption for receive processing may be approximately 60 mA with a supply voltage higher than 3.1V, and 70 mA for transmit processing at OdBm transmit power. However, the output power provided by an energy harvester may be below 1 milliwatt, considering the small size of a few square centimeters for practical devices. Since the available power may be far less than the consumed power, it may be impractical to power cellular devices directly by energy harvesting in most cases.

One possible solution is to integrate energy harvesting with a rechargeable battery or supercapacitor. However, there are still a few issues to be solved. Firstly, both the rechargeable battery and supercapacitor may suffer from a shortened lifetime in practical cases. It is difficult to provide a constant charging current or voltage by energy harvesting, while long-time continuous charging may be needed due to the very small output power from the energy harvester. An inconstant charging current and long-time continuous charging are both harmful to battery life. For a supercapacitor, the lifetime may be significantly reduced in high-temperature environments (e.g., less than 3 years at 50 degrees centigrade).

Secondly, the device size may be significantly increased, if the device is equipped with a battery or supercapacitor. As a small-size button battery can provide a current of just a few tens of milliamperes, a battery with a much larger size (e.g., AA battery) may be needed to power cellular devices, but the size of the battery may be even larger than the NB-IOT module itself. To store energy for a proper duration of working (e.g., one second), the required capacitance of a supercapacitor may be at the level of a hundred milli-farads. The size of such supercapacitors may also be larger than the NB-IOT module itself.

RFID is a technology supporting batteryless tags (devices). The power consumption of commercial passive RFID tags may be as low as 1 microwatt. The key techniques enabling such low power consumption are envelope detection for downlink data reception, and backscatter communication for uplink data transmission. RFID is designed for short-range communications, whose effective range may be less than 10 meters. As the air interface of RFID has remained almost unchanged since 2005, this simple transmission scheme may become an obstacle for improving its link budget and capability of supporting a scalable network.

Backscatter communication is an energy-efficient communication technology for IoT devices, for example. With backscatter communication, the IoT devices may reflect or backscatter an external excitation signal (e.g., power beacon) by tuning a set of antenna impedances. Subsequently, the frequency, phase, and/or amplitude of the excitation signal may be modulated according to the data of these IoT devices. Backscatter communication may enable the IoT devices to transmit their data without active transmission of radio frequency (RF) signals, which results in lower energy consumption. IoT devices and/or other user devices can use backscattering to communicate with their peers and/or relay information to other devices.

There may be three types of backscatter communication systems: monostatic backscatter communication, bistatic backscatter communication, and ambient backscatter communication. In monostatic backscatter communication, the backscattering device (e.g., IoT device) modulates and reflects a dedicated excitation signal that is transmitted by the intended receiver of the data.

In bistatic backscatter communication, the IoT device modulates and reflects a dedicated high-power excitation signal from an RF source (e.g., a base station or a TV tower), which is different from the intended receiver.

In ambient backscatter communication, the dedicated high-power excitation signal is replaced by an RF data signal that is intended for other device(s). Hence, ambient backscatter communication does not require the generation of dedicated excitation signals.

Attracted by the low power consumption of backscatter communication, many non-3GPP technologies begin to put efforts into related research, such as WiFi, Bluetooth, ultra-wide band (UWB), and long range (LoRa). Various research shows that a few or tens of microwatts of power consumption can be achieved for passive tags based on or with small modifications to the above air interfaces. For example, a LoRa tag implemented with commercial off-the-shelf components can send its sensing data to the receiver from up to 381 meters away.

To support LPHAP in 5G NR, the following two requirements may need to be addressed: low power to enable at least 6-9 months of battery life, and a positioning accuracy of less than 1 meter in RRC_INACTIVE or RRC_IDLE state.

The low power enabling at least 6-9 months of battery life may require changes to the RRC_IDLE state, as the current 5G NR system may not be able to operate for 6-9 months in its current RRC_IDLE state, even without including power consumption from positioning sessions. Thus, a problem to be addressed is the RRC_IDLE state power consumption and minimizing any overhead power consumption from adding positioning on top.

The high accuracy requirement may be supported by using current RRC active (RRC_CONNECTED) state positioning schemes for 5G NR with large bandwidths, but these need to be enabled for RRC_INACTIVE and RRC_IDLE state as well.

Some example embodiments may enable accurate ranging/positioning in RRC_INACTIVE or RRC_IDLE state for example for LPHAP devices operating in 5G NR networks. However, it should be noted that some example embodiments are not limited to LPHAP devices, and they may also be used for any other user devices. Furthermore, some example embodiments are not limited to 5G NR networks.

Some example embodiments may provide a power-efficient RTT ranging/positioning method between a TRP and a user device that is in RRC_INACTIVE or RRC_IDLE state. This method may be called a hybrid RTT method herein, since it calculates the round-trip time from TRP transmission of a wake-up signal (WUS) towards the target user device in the DL to receiving a reference signal from the UE in the UL. Some example embodiments may enable improved accuracy and reduced power consumption for RRC_INACTIVE or RRC_IDLE ranging/positioning compared to, for example, DL/UL TDoA-based techniques.

For example, the reference signal transmitted by the UE in the UL may be a sounding reference signal for positioning (SRS-P) or any other uplink reference signal, such as a demodulation reference signal (DMRS) or a phase-tracking reference signal (PTRS).

Some example embodiments are described below using principles and terminology of 5G technology without limiting the example embodiments to 5G communication systems, however.

FIG. 2 illustrates an example of a wake-up receiver (WUR) architecture of a user device 200, which may be applied in some example embodiments. As depicted in FIG. 2, the user device 200 may be equipped with a wake-up receiver (WUR) 201, an NR modem 202, and an NR radio 203. The WUR 201 and the NR radio 203 may comprise the radio front-end of the user device 200. The NR radio 203 may refer to the main radio of the user device 200. The WUR 201 may be configured to monitor for wake-up signals, and to activate (wake up) the NR modem 202 of the user device, when a WUS is detected by the WUR 201. In the absence of a WUS, the WUR 201 does not activate (wake up) the NR modem 202. For example, the WUR 201 may be an ultra-low power consumption receiver or even a zero-current passive receiver (WPR). Herein the term “waking up” may refer to reduced mode wake-up for the hybrid RTT positioning session. In other words, based on the wake-up signal, the WUR 201 may trigger a wake-up of the NR modem 202 for positioning, but not for paging. In the embodiments, the term “wake-up” related to the positioning procedure, for example, the wake-up using the hybrid RTT, can be called a positioning wake up. In addition, the wake-up signals used for positioning purpose can be called positioning wake-up signals.

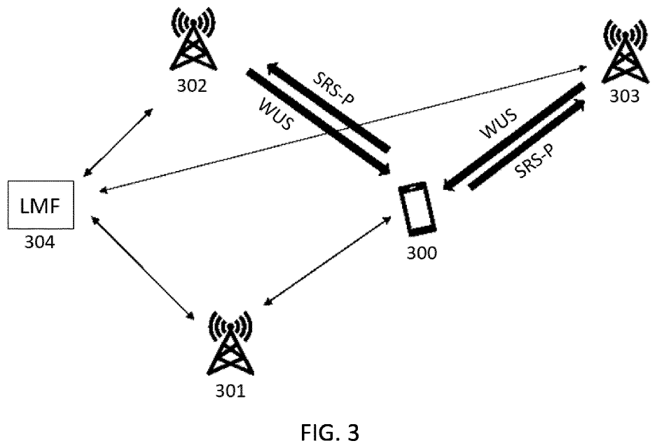

FIG. 3 illustrates an example of a system, to which some example embodiments may be applied. The system may comprise a user device 300, a serving network node (e.g., serving gNB) 301 of the user device 300, a first network node (e.g., gNB) 302, a second network node (e.g., gNB) 303, and a location management function (LMF) 304.

In an example embodiment, the user device 300 may transmit capability information to the serving network node 301, and the serving network node 301 may forward the capability information to the LMF 304. The capability information may comprise WUS capability information and hybrid RTT capability information.

The WUS capability information may indicate a wake-up receiver type of the user device and a charge time of the wake-up receiver. For example, the WUS capability information may indicate whether the wake-up receiver of the user device is an active WUR or passive WUR.

A passive WUR may mean that the WUR does not comprise a power source (e.g., battery), and instead uses energy harvesting to power itself. An active WUR may mean that the WUR is powered by a battery or other power source.

The charge time indicates a time period from when the wake-up receiver receives a wake-up signal to when the wake-up receiver is able to start decoding the wake-up signal. The charging may mean, for example, that the WUR harvests energy from the received wake-up signal and stores the energy in a capacitor. The charge time may be UE-specific, and it may also depend on the distance between the user device and the network node transmitting the WUS.

The hybrid RTT capability information may indicate that the user device 300 supports decoding the WUS payload, performing WUS arrival time estimation, transmitting a reference signal such as SRS-P in the uplink, and reporting the time difference between reception of the WUS and transmission of the reference signal.

The LMF 304 initiates a WUS hybrid RTT ranging session between the UE and a selected TRP, for example the first network node 302.

The LMF 304 may configure the selected TRP for: 1) WUS transmission with WUS signal carrying UE ID, Hybrid RTT trigger and WUS occasion index, and 2) UL SRS-P reception and measurement reporting.

The LMF 304 may prepare the selected TRP (e.g., the first network node 302) for SRS-P reception and trigger WUS transmission towards the user device 300. The WUS may comprise an identifier of the user device 300 (UE ID), a wake-up signal occasion index, and a hybrid RTT trigger. The hybrid RTT trigger is an indication for triggering the user device 300 to transmit SRS-P, as well as determine and report the time difference between WUS reception and SRS-P transmission.

The WUR of the user device 300 charges on the WUS (i.e., harvests energy from the WUS) and triggers decoding of the UE ID, hybrid RTT trigger and WUS occasion index for activating the modem 202 of the user device specifically for hybrid RTT. Upon being activated by the WUR, the UE wakes up and enables reduced modem functionality adequate for the positioning wake-up procedure including initiating UL SRS-P transmission and reporting the time difference.

The user device determines and reports, to the serving network node 301, the time difference between WUS reception and SRS-P transmission for example via physical random access channel (PRACH) or small data transmission (SDT) reporting. After transmitting the report, the user device 300 may go back to sleep. The serving network node 301 may forward the report to the LMF 304.

Herein the sleeping refers to the discontinuous reception (DRX) sleep state (with the modem 202 power off), which is part of RRC idle/inactive state. The UE may be in RRC idle or inactive state, while transmitting the SRS-P, measuring the time difference, and transmitting the report. After transmitting the report (e.g., via SDT or PRACH), the UE may go back to sleep while remaining in the RRC idle or inactive state.

The selected TRP (e.g., the first network node 302) measures the SRS-P arrival time and reports the time difference between WUS transmission and SRS-P reception to the LMF 304.

The LMF 304 determines the hybrid RTT based on the time differences reported by at least the user device 300 and/or the selected TRP 302. The hybrid RTT refers to the round-trip time from the transmission of the WUS from the selected TRP 302 to the reception of the SRS-P at the selected TRP 302. Based on the hybrid RTT, the LMF 304 may determine the ranging distance between the selected TRP 302 and the UE 300.

The LMF 304 may retrigger the hybrid RTT ranging session with one or more other TRPs, for example the second network node 303, to enable position estimation of the user device 300.

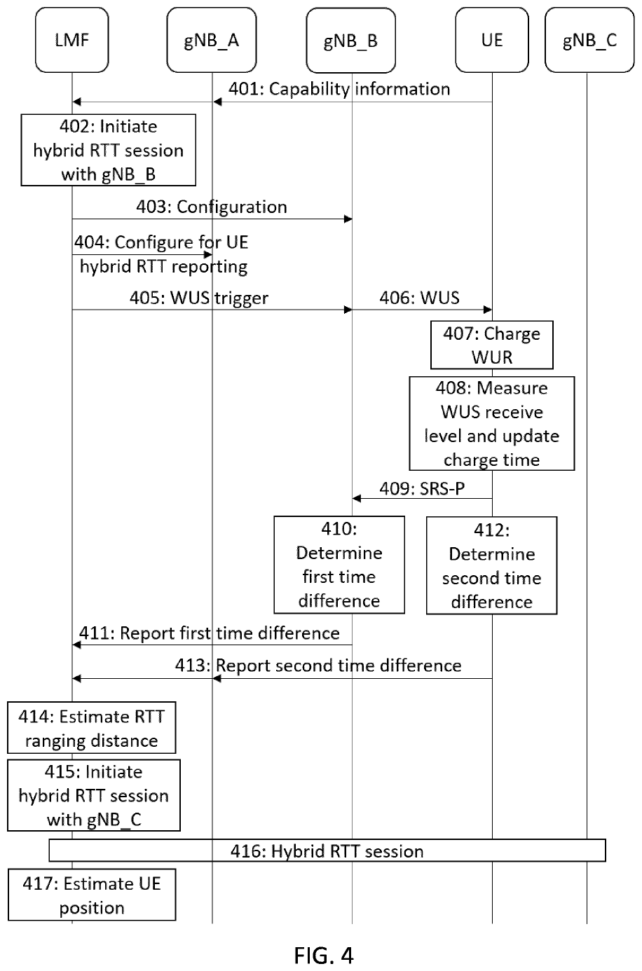

FIG. 4 illustrates a signaling diagram according to an example embodiment. The user device (UE) of FIG. 4 may be in RRC_INACTIVE state or RRC_IDLE state at least during blocks 402-417. In block 401, the user device may be in an RRC active (e.g., RRC_CONNECTED) state.

Referring to FIG. 4, in block 401, the user device (e.g., the user device 300) transmits capability information of the user device to its serving network node (e.g., serving gNB 301). The serving network node forwards the capability information to an LMF. The serving network node is denoted as “gNB_A” in FIG. 4.

The capability information indicates at least a hybrid RTT capability of the user device. The hybrid RTT capability means that the user device supports decoding the WUS payload, estimating the WUS arrival time, transmitting a reference signal (e.g., SRS-P) in the uplink, and determining and reporting the time difference between reception of the WUS and transmission of the reference signal. This time difference may be referred to as a second time difference herein.

The capability information may further indicate at least one of: a type of a wake-up receiver of the user device, and/or a charge time of the wake-up receiver, wherein the charge time indicates a time period from when the wake-up receiver receives a wake-up signal to when the wake-up receiver is able to start decoding the wake-up signal. The type of the wake-up receiver may indicate whether the WUR is active or passive. The indication of the charge time may implicitly indicate that the user device supports the hybrid RTT capability. Alternatively, the user device may explicitly indicate that it supports the hybrid RTT capability.

In block 402, the LMF initiates a hybrid RTT session between the user device and at least one selected TRP, for example a first network node (denoted as gNB_B in FIG. 4). The TRP selection may be based on prior location knowledge. For example, the TRP (e.g., gNB_B) may be picked from a list of TRPs including the serving network node and a set of neighboring network nodes close to the serving network node. As another example, the initial selection may be based on an estimated best link budget among the list of TRPs.

Herein the term TRP may refer to a transmission and reception point of a gNB, and the TRP may be the physical coordinates reference for positioning. Herein the terms gNB and TRP may be used interchangeably to represent the same entity.

In block 403, the LMF determines, for the first network node (e.g., gNB 302), based at least on the capability information of the user device, a configuration for at least one of: the transmission of a first wake-up signal, the reception of a first reference signal (e.g., SRS-P), and/or reporting a time difference between the transmission of the first wake-up signal from the first network node and the reception of the first reference signal at the first network node. This time difference may be referred to as a first time difference herein.

The configuration may indicate that the first wake-up signal should comprise an identifier of the user device (UE ID), a wake-up signal occasion index, and an indication (hybrid RTT trigger) for triggering determining and reporting of the second time difference between the reception of the first wake-up signal and the transmission of the first reference signal at the user device.

The wake-up signal occasion index may be an index number or other type of reference time stamp for distinguishing different WUS transmission time occasions from each other and to identify the time occasion, which is detected at the wake-up receiver of a given user device to be referenced in the reporting.

The configuration may also indicate the duration of the first wake-up signal, i.e., for how long the selected TRP should transmit the first wake-up signal. The ON duration of the first wake-up signal may be based on the charge time of the wake-up receiver, as indicated by the capability information of the user device. In other words, the duration of the first wake-up signal may be at least as large as the sum of the maximum delay to the cell edge and the WUR charge time.

The LMF transmits the configuration to the first network node.

In block 404, the LMF configures the serving network node of the user device for reporting, or forwarding, the first time difference from the user device to the LMF.

In block 405, the LMF transmits a WUS trigger to the first network node and prepares the first network node for receiving the first reference signal from the user device. The WUS trigger indicates the first network node to transmit the wake-up signal to the user device.

In block 406, the first network node transmits the first wake-up signal to the user device, wherein the first wake-up signal comprises the identifier of the user device (UE ID), the wake-up signal occasion index, and the indication (hybrid RTT trigger) for triggering determining and reporting of the time difference between the reception of the first wake-up signal and the transmission of the first reference signal at the user device. The first wake-up signal may be used to both trigger the hybrid RTT session and as a DL signal in the RTT session.

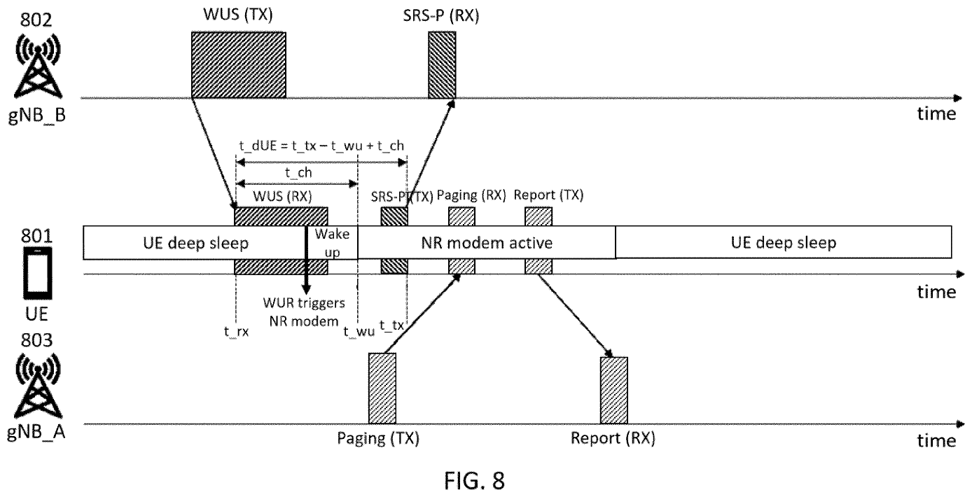

In block 407, the wake-up receiver of the user device receives the first wake-up signal and charges on the first wake-up signal for a time period denoted as t_ch, which may depend on the available WUS power and/or distance to the WUS transmitter (gNB_B), and triggers UE wake-up (see the example of FIG. 8). The charging may mean that the wake-up receiver harvests energy from the received first wake-up signal and stores the energy in a capacitor.

For a purely passive wake-up receiver with no battery, the charge time t_ch should be long enough to trigger and perform decoding of the UE ID and hybrid RTT trigger for activating (waking up) the NR modem of the user device.

For a passive wake-up receiver with a battery connected, the charge time t_ch should be long enough to enable a passively triggered power-up of the battery-supplied decoder of the UE ID and hybrid RTT trigger for activating (waking up) the NR modem of the user device.

The time of wake-up/activation denoted as t_wu may be logged at the UE, and the reception time (t_rx) of the first wake-up signal may be recorded as t_rx=t_wu−t_ch, i.e., by also taking into account the charge time t_ch. Taking into account the charge time may make the reception time estimate more accurate.

The user device may have a local model for the charge time t_ch, which may be impacted for example by the receive level of the first wake-up signal. The longer the distance between the user device and the first network node is, the lower the receive level and the longer the charge time t_ch are. The receive level may be measured after the trigger and used to adjust, or update, the charge time t_ch.

In block 408, the user device measures the receive level of the first wake-up signal and estimates an updated charge time of the wake-up receiver (i.e., adjusts the charge time estimate) based on the measured receive level. The receive level may refer to, for example, the received power of the first wake-up signal.

In block 409, the user device wakes up from DRX sleep and enables reduced modem functionality adequate for initiating the transmission of the first reference signal at time t_tx. The user device may transmit the first reference signal to the first network node in response to receiving the first wake-up signal. That is, the user device, which may be in RRC idle or inactive state, receives the first wake-up signal, decodes the payload of the first wake-up signal, and determines, based on the decoded payload, that the first wake-up signal is intended for this particular user device (e.g., based on the UE ID). Based on determining that the first wake-up signal is intended for this user device, a positioning transmitter of the user device is triggered to generate/transmit the first reference signal. The first reference signal may be, for example, UL SRS-P or any other uplink reference signal.

In block 410, the first network node measured the arrival time of the first reference signal and determines, or measures, the first time difference between the transmission of the first wake-up signal from the first network node and the reception of the first reference signal at the first network node.

In block 411, the first network node reports, to the LMF, first information indicating the first time difference. The first information may comprise, for example, one or more values indicating the first time difference.

In block 412, the user device determines, or measures, the second time difference (t_dUE=t_tx−t_rx) between the reception of the first wake-up signal at the user device and the transmission of the first reference signal from the user device. The user device may determine the second time difference based at least partly on the charge time of the wake-up receiver of the user device, i.e., by taking into account the charge time of the wake-up receiver as described above.

In block 413, the user device reports, to the LMF via the serving network node, second information indicating the second time difference and the wake-up signal occasion index. In other words, the user device transmits the report to the serving network node, and the serving network node transparently forwards the report to the LMF according to the configuration of block 404. For example, the user device may transmit the report via PRACH or SDT reporting. The second information may comprise, for example, one or more values indicating the second time difference.

In case the wake-up signal is transmitted several times, it may be beneficial for the user device to include the wake-up signal occasion index in the reporting, so that the LMF is aware of the report reference.

The user device may also include the updated charge time, t_ch, in the report. This enables the LMF to adjust the WUS transmission duration (on-time) accordingly for future hybrid-RTT sessions, thereby reducing resource overhead at the network side.

The user device may go back to sleep (i.e., DRX sleep) after the reporting.

In block 414, based at least on the received first information and second information, the LMF determines a first round-trip time (hybrid RTT) from the transmission of the first wake-up signal to the reception of the first reference signal. Based on the first round-trip time, the LMF may estimate the ranging distance between the first network node and the user device.

In block 415, the LMF may retrigger the hybrid RTT ranging session (e.g., the positioning wake up procedure) with one or more other network nodes, for example a second network node (denoted as gNB_C in FIG. 4), to enable position estimation of the user device. In other words, the LMF may initiate one or more additional hybrid RTT ranging sessions between the user device and the one or more other network nodes.

In block 416, the one or more additional hybrid RTT ranging sessions may be performed with the one or more other network nodes. In other words, blocks 403-414 may be repeated with the one or more other network nodes (i.e., the one or more other network nodes may perform the role of the first network node gNB_B described above).

For example, the LMF may obtain third information indicating a time difference between a transmission of a second wake-up signal from the second network node and a reception of a second reference signal (e.g., SRS-P) at the second network node, wherein the second network node is different to the first network node. Further, the LMF may obtain fourth information indicating a time difference between a reception of the second wake-up signal at the user device and a transmission of the second reference signal from the user device. The LMF may then determine, based at least on the third information and the fourth information, a second round-trip time from the transmission of the second wake-up signal to the reception of the second reference signal.

In block 417, the LMF estimates the position (location) of the user device based at least partly on the first information and second information reported during the hybrid RTT session between the user device and the first network node (gNB_B), as well as the time differences reported during the one or more additional hybrid RTT sessions between the user device and the one or more other network nodes (e.g., gNB_C).

Herein the terms “first network node” and “second network node” are used to distinguish the network nodes, and they do not necessarily mean specific identifiers of the network nodes.

Furthermore, the terms “first time difference” and “second time difference” are used to distinguish the time differences, and they do not necessarily mean the order in which they are determined. Similarly, the terms “first information” and “second information” are used to distinguish the information, and they do not necessarily mean the order in which they are reported.

Furthermore, the terms “first wake-up signal” and “second wake-up signal” are used to distinguish the wake-up signals. In this case, the first and second wake-up signals used for the positioning can be called the first positioning wake-up signal and the second positioning wake-up signal, respectively.

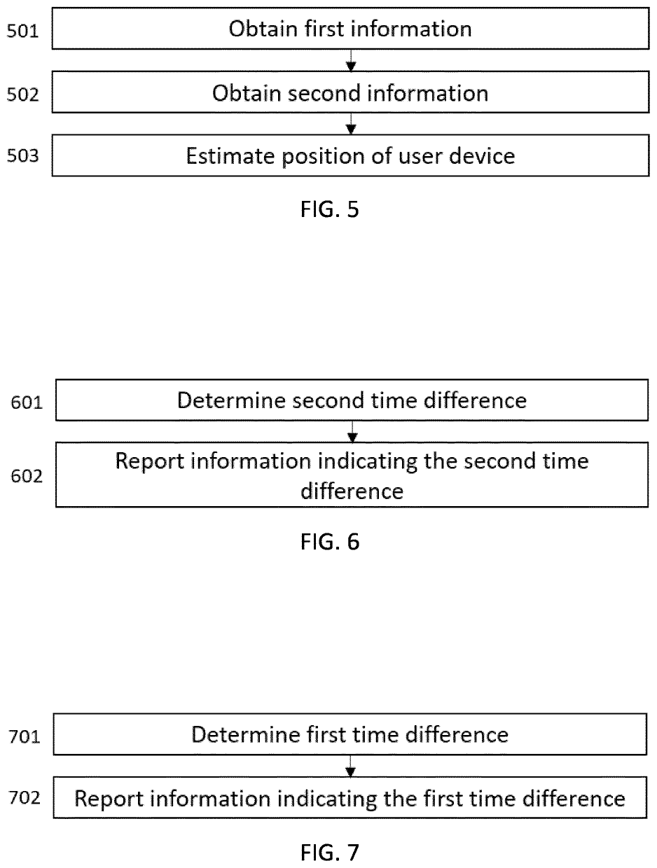

FIG. 5 illustrates a flow chart according to an example embodiment of a method performed by an apparatus. For example, the apparatus may be, or comprise, or be comprised in, a core network entity such as a location management function (LMF). The LMF may correspond to the LMF 112 of FIG. 1 or the LMF 304 of FIG. 3.

Referring to FIG. 5, in block 501, first information is obtained indicating a first time difference between a transmission of a wake-up signal from a first network node and a reception of a reference signal at the first network node.

In block 502, second information is obtained indicating a second time difference between a reception of the wake-up signal at a user device and a transmission of the reference signal from the user device.

In block 503, a position of the user device is estimated based at least partly on the first information and the second information.

FIG. 6 illustrates a flow chart according to an example embodiment of a method performed by an apparatus. For example, the apparatus may be, or comprise, or be comprised in, a user device. The user device may also be called a subscriber unit, mobile station, remote terminal, access terminal, user terminal, terminal device, or user equipment (UE). The user device may correspond to one of the user devices 100, 102 of FIG. 1 or the user device 300 of FIG. 3.

Referring to FIG. 6, in block 601, a second time difference between a reception of a wake-up signal at the apparatus and a transmission of a reference signal from the apparatus is determined.

In block 602, information indicating the second time difference is reported.

FIG. 7 illustrates a flow chart according to an example embodiment of a method performed by an apparatus. For example, the apparatus may be, or comprise, or be comprised in, a network node of a radio access network. The network node may correspond to the access node 104 of FIG. 1, or to the first network node 302 of FIG. 3, or to the first network node of FIG. 4.

Referring to FIG. 7, in block 701, a first time difference between a transmission of a wake-up signal from the apparatus and a reception of a reference signal at the apparatus is determined.

In block 702, information indicating the first time difference is reported.

The blocks, related functions, and information exchanges (messages) described above by means of FIGS. 4-7 are in no absolute chronological order, and some of them may be performed simultaneously or in an order differing from the described one. Other functions can also be executed between them or within them, and other information may be sent, and/or other rules applied. Some of the blocks or part of the blocks or one or more pieces of information can also be left out or replaced by a corresponding block or part of the block or one or more pieces of information.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

FIG. 8 illustrates an example of the series of events in an example embodiment. In FIG. 8, TX denotes transmission and RX denotes reception. t_rx denotes the reception time of the wake-up signal at the user device (UE) 801. t_ch denotes the charge time of the wake-up receiver. t_wu denotes the wake-up time of the user device. t_tx denotes the transmission time of the reference signal (e.g., SRS-P) at the user device. t_dUE denotes the time difference between the reception of the wake-up signal and the transmission of the reference signal, wherein this time difference may also take into account the charge time t_ch.

Referring to FIG. 8, initially the user device 801 is in deep sleep. If the user device has a passive or semi-passive wake-up receiver (WUR), the WUR may need to charge on the incoming energy of the wake-up signal (WUS) for a certain amount of time (charge time t_ch), i.e., to harvest energy from the received wake-up signal. When the WUR has charged enough, the user device can wake up, record the wake-up time, measure the received power level of the wake-up signal, and start decoding the content of the wake-up signal. This charge time depends on the available power, and thus also on the distance between the user device and the network node (e.g., gNB_B) 802 transmitting the wake-up signal.

After waking up and decoding the wake-up signal, the user device 801 may transmit the reference signal to the network node, determine the time difference between WUS reception and SRS-P transmission, and report the time difference to its serving gNB (gNB_A) 803. After transmitting the report, the user device 801 may go back to sleep.

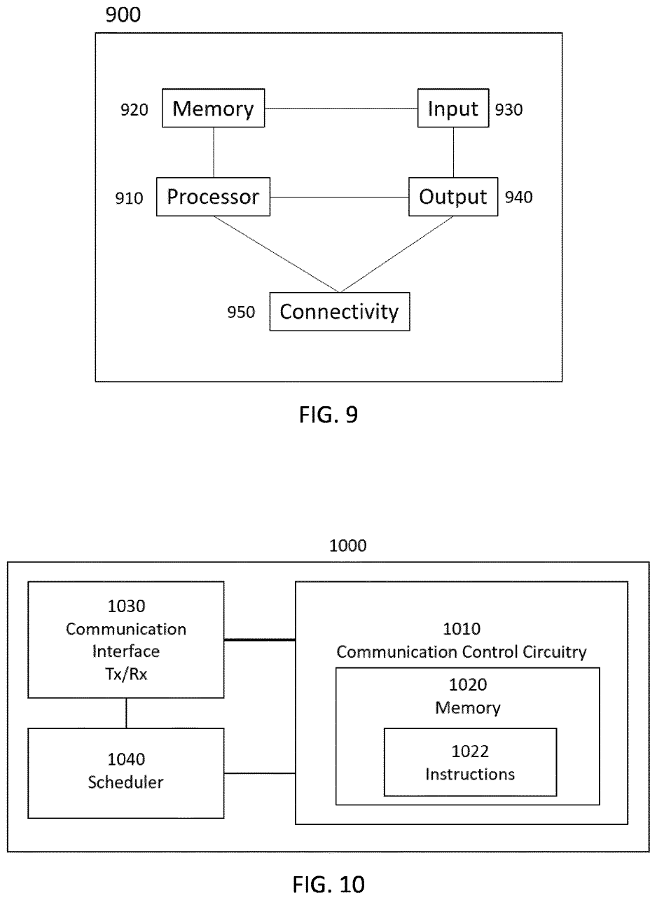

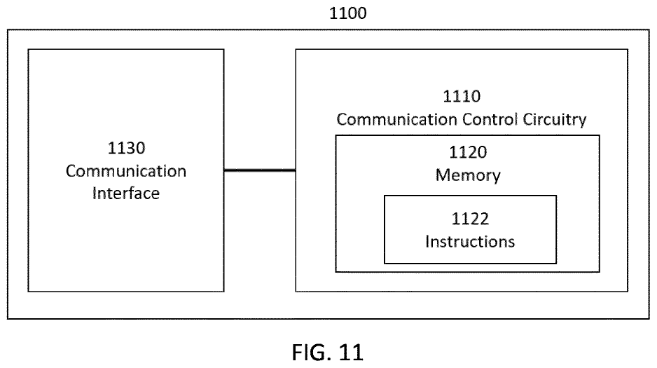

FIG. 9 illustrates an example of an apparatus 900 comprising means for performing one or more of the example embodiments described above. For example, the apparatus 900 may be an apparatus such as, or comprising, or comprised in, a user device. The user device may correspond to one of the user devices 100, 102 of FIG. 1 or the user device 300 of FIG. 3. The user device may also be called a subscriber unit, mobile station, remote terminal, access terminal, user terminal, terminal device, or user equipment (UE).

The apparatus 900 comprises at least one processor 910. The at least one processor 910 interprets instructions (e.g., computer program instructions) and processes data. The at least one processor 910 may comprise one or more programmable processors. The at least one processor 910 may comprise programmable hardware with embedded firmware and may, alternatively or additionally, comprise one or more application-specific integrated circuits (ASICs).

The at least one processor 910 is coupled to at least one memory 920. The at least one processor is configured to read and write data to and from the at least one memory 920. The at least one memory 920 may comprise one or more memory units. The memory units may be volatile or non-volatile. It is to be noted that there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The term “non-transitory,” as used herein, is a limitation of the medium itself (i.e., tangible, not a signal) as opposed to a limitation on data storage persistency (e.g., RAM vs. ROM). The at least one memory 920 stores computer readable instructions that are executed by the at least one processor 910 to perform one or more of the example embodiments described above. For example, non-volatile memory stores the computer readable instructions, and the at least one processor 910 executes the instructions using volatile memory for temporary storage of data and/or instructions. The computer readable instructions may refer to computer program code.

The computer readable instructions may have been pre-stored to the at least one memory 920 or, alternatively or additionally, they may be received, by the apparatus, via an electromagnetic carrier signal and/or may be copied from a physical entity such as a computer program product. Execution of the computer readable instructions by the at least one processor 910 causes the apparatus 900 to perform one or more of the example embodiments described above. That is, the at least one processor and the at least one memory storing the instructions may provide the means for providing or causing the performance of any of the methods and/or blocks described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer. The term “non-transitory,” as used herein, is a limitation of the medium itself (i.e., tangible, not a signal) as opposed to a limitation on data storage persistency (e.g., RAM vs. ROM).

The apparatus 900 may further comprise, or be connected to, an input unit 930. The input unit 930 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units. Further, the input unit 930 may comprise an interface to which external devices may connect to.

The apparatus 900 may also comprise an output unit 940. The output unit may comprise or be connected to one or more displays capable of rendering visual content, such as a light emitting diode (LED) display, a liquid crystal display (LCD) and/or a liquid crystal on silicon (LCoS) display. The output unit 940 may further comprise one or more audio outputs. The one or more audio outputs may be for example loudspeakers.

The apparatus 900 further comprises a connectivity unit 950. The connectivity unit 950 enables wireless connectivity to one or more external devices. The connectivity unit 950 comprises at least one transmitter and at least one receiver that may be integrated to the apparatus 900 or that the apparatus 900 may be connected to. The at least one transmitter comprises at least one transmission antenna, and the at least one receiver comprises at least one receiving antenna. The connectivity unit 950 may comprise an integrated circuit or a set of integrated circuits that provide the wireless communication capability for the apparatus 900. Alternatively, the wireless connectivity may be a hardwired application-specific integrated circuit (ASIC). The connectivity unit 950 may also provide means for performing at least some of the blocks of one or more example embodiments described above. The connectivity unit 950 may comprise one or more components, such as: power amplifier, digital front end (DFE), analog-to-digital converter (ADC), digital-to-analog converter (DAC), frequency converter, (de)modulator, and/or encoder/decoder circuitries, controlled by the corresponding controlling units.

It is to be noted that the apparatus 900 may further comprise various components not illustrated in FIG. 9. The various components may be hardware components and/or software components.

FIG. 10 illustrates an example of an apparatus 1000 comprising means for performing one or more of the example embodiments described above. For example, the apparatus 1000 may be an apparatus such as, or comprising, or comprised in, a network node of a radio access network. The network node may correspond to the access node 104 of FIG. 1 or to the first network node 302 of FIG. 3. The network node may also be referred to, for example, as a network element, a radio access network (RAN) node, a next generation radio access network (NG-RAN) node, a NodeB, an eNB, a gNB, a base transceiver station (BTS), a base station, an NR base station, a 5G base station, an access node, an access point (AP), a relay node, a repeater, an integrated access and backhaul (IAB) node, an IAB donor node, a distributed unit (DU), a central unit (CU), a baseband unit (BBU), a radio unit (RU), a radio head, a remote radio head (RRH), or a transmission and reception point (TRP).

The apparatus 1000 may comprise, for example, a circuitry or a chipset applicable for realizing one or more of the example embodiments described above. The apparatus 1000 may be an electronic device comprising one or more electronic circuitries. The apparatus 1000 may comprise a communication control circuitry 1010 such as at least one processor, and at least one memory 1020 storing instructions 1022 which, when executed by the at least one processor, cause the apparatus 1000 to carry out one or more of the example embodiments described above. Such instructions 1022 may, for example, include a computer program code (software), wherein the at least one memory and the computer program code (software) are configured, with the at least one processor, to cause the apparatus 1000 to carry out one or more of the example embodiments described above. The at least one processor and the at least one memory storing the instructions may provide the means for providing or causing the performance of any of the methods and/or blocks described above.

The processor is coupled to the memory 1020. The processor is configured to read and write data to and from the memory 1020. The memory 1020 may comprise one or more memory units. The memory units may be volatile or non-volatile. It is to be noted that there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The term “non-transitory,” as used herein, is a limitation of the medium itself (i.e., tangible, not a signal) as opposed to a limitation on data storage persistency (e.g., RAM vs. ROM). The memory 1020 stores computer readable instructions that are executed by the processor. For example, non-volatile memory stores the computer readable instructions and the processor executes the instructions using volatile memory for temporary storage of data and/or instructions.

The computer readable instructions may have been pre-stored to the memory 1020 or, alternatively or additionally, they may be received, by the apparatus, via an electromagnetic carrier signal and/or may be copied from a physical entity such as a computer program product. Execution of the computer readable instructions causes the apparatus 1000 to perform one or more of the functionalities described above.

The memory 1020 may be implemented using any suitable data storage technology, such as semiconductor-based memory devices, flash memory, magnetic memory devices and systems, optical memory devices and systems, fixed memory and/or removable memory. The memory may comprise a configuration database for storing configuration data. For example, the configuration database may store a current neighbour cell list, and, in some example embodiments, structures of the frames used in the detected neighbour cells.

The apparatus 1000 may further comprise a communication interface 1030 comprising hardware and/or software for realizing communication connectivity according to one or more communication protocols. The communication interface 1030 comprises at least one transmitter (Tx) and at least one receiver (Rx) that may be integrated to the apparatus 1000 or that the apparatus 1000 may be connected to. The communication interface 1030 may provide means for performing some of the blocks for one or more example embodiments described above. The communication interface 1030 may comprise one or more components, such as: power amplifier, digital front end (DFE), analog-to-digital converter (ADC), digital-to-analog converter (DAC), frequency converter, (de)modulator, and/or encoder/decoder circuitries, controlled by the corresponding controlling units.

The communication interface 1030 provides the apparatus with radio communication capabilities to communicate in the cellular communication system. The communication interface may, for example, provide a radio interface to one or more user devices. The apparatus 1000 may further comprise another interface towards a core network such as the network coordinator apparatus or AMF, and/or to the access nodes of the cellular communication system.

The apparatus 1000 may further comprise a scheduler 1040 that is configured to allocate radio resources. The scheduler 1040 may be configured along with the communication control circuitry 1010 or it may be separately configured.

It is to be noted that the apparatus 1000 may further comprise various components not illustrated in FIG. 10. The various components may be

1.-19. (canceled)

20. An apparatus comprising:
at least one processor; and
at least one memory storing instructions which, when executed by the at least one processor, cause the apparatus at least to:
initiate a hybrid round trip time (RTT) session between a user device and a first network node;
receive capability information of the user device, wherein the capability information indicates: the user device is hybrid round trip time (RTT) capable, which indicates the user device supports: decoding a wake-up signal (WUS) payload, estimating the WUS arrival time, transmitting a reference signal in an uplink, and determining and reporting a time difference between reception of the WUS and transmission of the reference signal a capability to determine and report a second time difference between a reception of the wake-up signal at the user device and a transmission of the reference signal from the user device, a type of a wake-up receiver of the user device, and a charge time of the wake-up receiver, wherein the charge time indicates a time period from when the wake-up receiver receives the wake-up signal to when the wake-up receiver is able to start decoding the wake-up signal;
determine, for the first network node, based at least on the capability information, a configuration for the transmission of the wake-up signal, the reception of the reference signal, and reporting a first time difference between a transmission of the first wake-up signal from the first network node and a reception of the reference signal at the first network node, wherein the wake-up signal comprises an identifier of the user device, a wake-up signal occasion index, and an indication for triggering determining and reporting of the second time difference;
transmit the configuration to the first network node;
obtain, from the first network node, first information indicating the first time difference between a transmission of a wake-up signal from the first network node and a reception of the reference signal at the first network node;
obtain, from the user equipment, second information indicating the second time difference; and
estimate a position of the user device based at least partly on the first information and the second information.

21. The apparatus according to claim 20, wherein the reference signal is transmitted from the user device in response to receiving the wake-up signal.

22. The apparatus according to claim 21, wherein the configuration further indicates a duration of the wake-up signal.

23. The apparatus according to claim 22, wherein the configuration further indicates that the wake-up signal should comprise an identifier of the user device (UE ID), a wake-up signal occasion index, and an indication (hybrid RTT trigger) for triggering, determining, and reporting of the second time difference between the reception of the first wake-up signal and the transmission of the reference signal at the user device.

24. A user device comprising:
at least one processor; and
at least one memory storing instructions which, when executed by the at least one processor, cause the user device at least to:
transmit capability information of the user device to a location management function (LMF), wherein the capability information indicates: the user device is hybrid round trip time (RTT) capable, which indicates the user device supports: decoding a wake-up signal (WUS) payload, estimating the WUS arrival time, transmitting a reference signal in an uplink, and determining and reporting a time difference between reception of the WUS and transmission of the reference signal a capability to determine and report a second time difference between a reception of the wake-up signal at the user device and a transmission of the reference signal from the user device, a type of a wake-up receiver of the user device, and a charge time of the wake-up receiver, wherein the charge time indicates a time period from when the wake-up receiver receives the wake-up signal to when the wake-up receiver is able to start decoding the wake-up signal
based on the capability information, receiving, from a first network node, a wake-up signal and charges on the wake-up signal for a time period;
estimating a charge time of a wake-up receiver of the user device based on a receive level of the wake-up signal, the receive level indicating a power of the wake-up signal;
decoding a payload of the wake-up signal;
determining, based on the decoded payload, that the wake-up signal is intended for the user device;
waking the user device up from discontinuous reception (DRX) sleep;
enabling reduced modem functionality adequate for initiating the transmission of the reference signal;
transmitting the reference signal based on determining that the wake-up signal is intended for the user device;
determining, based on the charge time of the wake-up receiver of the user device, a time difference between a reception of the wake-up signal and a transmission of the reference signal from the user device, wherein the charge time indicates a time period from when the wake-up receiver receives the wake-up signal to when the wake-up receiver is able to start decoding the wake-up signal; and
reporting, to the LMF, information indicating the time difference for estimating a position of the user device.

25. The user device according to claim 24, wherein the wake-up signal comprises an identifier of the user device, a wake-up signal occasion index, and an indication for triggering the determining and the reporting of the second time difference.

26. The user device according to claim 25, wherein the time period is based on an available wake up signal power and distance to the WUS transmitter.

27. The user device according to claim 26, wherein the user device is in a radio resource control idle state.

28. The user device according to claim 26, wherein the user device is in an inactive state.

29. A method comprising:
initiating a hybrid round trip time (RTT) session between a user device and a first network node;
receiving capability information of a user device, wherein the capability information indicates: the user device is hybrid round trip time (RTT) capable, which indicates the user device supports: decoding a wake-up signal (WUS) payload, estimating the WUS arrival time, transmitting a reference signal in an uplink, and determining and reporting a time difference between reception of the WUS and transmission of the reference signal a capability to determine and report a second time difference between a reception of the wake-up signal at the user device and a transmission of the reference signal from the user device, a type of a wake-up receiver of the user device, and a charge time of the wake-up receiver, wherein the charge time indicates a time period from when the wake-up receiver receives the wake-up signal to when the wake-up receiver is able to start decoding the wake-up signal;
determining, for the first network node, based at least on the capability information, a configuration for the transmission of the wake-up signal, the reception of the reference signal, and reporting a first time difference between a transmission of the first wake-up signal from the first network node and a reception of the reference signal at the first network node, wherein the wake-up signal comprises an identifier of the user device, a wake-up signal occasion index, and an indication for triggering determining and reporting of the second time difference;
transmitting the configuration to the first network node;
obtaining, from the first network node, first information indicating the first time difference between a transmission of a wake-up signal from the first network node and a reception of the reference signal at the first network node;
obtaining, from the user equipment, second information indicating the second time difference; and
estimating a position of the user device based at least partly on the first information and the second information.

30. The method according to claim 29, wherein the reference signal is transmitted from the user device in response to receiving the wake-up signal.

31. The method according to claim 30, wherein the configuration further indicates a duration of the wake-up signal.

32. The method according to claim 31, wherein the configuration further indicates that the wake-up signal should comprise an identifier of the user device (UE ID), a wake-up signal occasion index, and an indication (hybrid RTT trigger) for triggering, determining, and reporting of the second time difference between the reception of the first wake-up signal and the transmission of the reference signal at the user device.
